(19) United States
(12) Patent Application Publication
(10) Pub. No.: US 2025/0215145 A1
(43) Pub. Date: Jul. 3, 2025

(54) POLYURETHANE COMPOSITIONS, COMPOSITE MATERIALS PREPARED WITH SAME AND PREPARATION METHODS THEREOF

(71) Applicants: Dow Global Technologies LLC, Midland, MI (US); ROHM AND HAAS COMPANY, Collegeville, PA (US)

(72) Inventors: Fang Du, Dortmund (DE); Luigi Pellacani, Carpi (IT); Kunpeng Guo, Shanghai (CN); Shaoguang Feng, Shanghai (CN); Gang Sun, Shanghai (CN); Guido Bramante, Tarragona (ES)

(21) Appl. No.: 18/850,230

(22) PCT Filed: Mar. 25, 2022
(86) PCT No.: PCT/CN2022/093318

§ 371 Date: Sep. 24, 2024

(51) Int. Cl. C08G 18/67; C08G 18/04; C08G 18/12; C08G 18/48; C08G 18/76; C08J 5/04

(52) U.S. Cl. CPC C08G 18/6755; C08G 18/04; C08G 18/12; C08G 18/4829; C08G 18/7671; C08J 5/04; C08J 2375/16

(57) ABSTRACT

A polyurethane composition, a composite material comprising a fiber reinforcement material and a polyurethane resin obtained from the polyurethane composition, and a method for preparing the polyurethane resin are provided. The polyurethane composition comprises: A) an isocyanate component; B) an isocyanate-reactive component comprising B1) a first polyol; B2) an isocyanate reactive (meth) acrylate monomer; and B3) an acetoacetoxy functional or acetoacetamido functional (meth) acrylate monomer; and C) a free radical initiator.

### FIELD OF THE INVENTION

The present disclosure relates to a polyurethane composition, a composite material comprising a fiber reinforcement material and a polyurethane resin obtained from the polyurethane composition, and a method for preparing the polyurethane resin. The reacted polyurethane resin has a low content of un-reacted NCO and shows improved polymer properties, which makes it suitable for a broad range of composite manufacturing processes and end applications.

### BACKGROUND TECHNOLOGY

Composite materials are a type of heterogeneous materials, comprising fiber reinforcement materials to provide high strength and a polymer matrix to fix and protect the fibers. The performance and service life of the composite material not only depend on the reinforcement materials, but also highly depend on the quality of impregnation and the properties of the polymer matrix. Liquid resins should have low viscosity and long open time to ensure good impregnation quality and processability, while providing a cure time to allow for adequate production cycle time. Apart from that, physical mechanical properties, thermal stability, conversion degree of the functional groups in the cured resin are also important.

Polyurethane resins show low exotherm, good surface quality and superior physical mechanical properties such as high toughness and fatigue resistance. However, the intrinsically fast reactivity leading to short open time makes conventional 2k polyurethane (PU) solutions unsuitable for some composite manufacturing processes requiring long open time, for instance, vacuum infusion. Recently, a hybrid PU system containing ethylenically unsaturated monomer has been developed, which shows significantly extended open time. U.S. Ser. No. 10/344,130B2 discloses a composition containing isocyanate, polyol and HPMA, where the NCO+OH reaction and free radical polymerization occur simultaneously after blending all components in one pot, showing a maximum open time of 115 min and optimal performance when the polyol in the range of 21-60%. However, after polymerization of such hybrid cure system, a substantial amount of unreacted NCO often remains in the cured articles, which is indicative of incomplete polymerization and which may have a negative impact on polymer properties, such as Heat Distortion Temperature (HDT), and compromise long term material performance.

For the above reasons, there is still an unanswered need in the polyurethane manufacture industry to develop a hybrid polyurethane composition having a low content of un-reacted NCO and improved polymer properties when it is cured. After persistent exploration, the inventors have surprisingly developed a hybrid polyurethane composition which achieves the above mentioned desirable features when it is cured.

### SUMMARY OF THE INVENTION

The present disclosure provides a unique polyurethane composition, especially for composite applications, a composite material comprising a fiber reinforcement material and a polyurethane resin obtained from the polyurethane composition, and a method for preparing the polyurethane resin.

In a first aspect of the present disclosure, the present disclosure provides a polyurethane composition comprising
A) an isocyanate component;
B) an isocyanate-reactive component comprising
   B1) a first polyol;
   B2) an isocyanate reactive (meth)acrylate monomer; and
   B3) an acetoacetoxy functional or acetoacetamido functional (meth)acrylate monomer; and
C) a free radical initiator.

The polyurethane composition may further comprise other additives. The additives can be selected from the group consisting of catalysts for the reaction between the isocyanate group and the hydroxyl group, radical polymerization accelerators, defoamers, pigments, fillers, inhibitors, and moisture scavengers.

In a second aspect of the present disclosure, the present disclosure provides a composite material comprising a fiber reinforcement material and a polyurethane resin obtained from the polyurethane composition described herein.

In a third aspect of the present disclosure, the present disclosure provides a method of preparing a polyurethane resin comprising:
1) providing an isocyanate component A),
2) providing an isocyanate-reactive component B), comprising
   B1) a first polyol; and
   B2) an isocyanate reactive (meth)acrylate monomer; and
   B3) an acetoacetoxy functional or acetoacetamido functional (meth)acrylate monomer;
3) providing a free radical initiator C); and
4) then reacting the isocyanate component A) with the isocyanate-reactive component B) in the presence of the free radical initiator C) to form the polyurethane resin.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

### Definitions

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. To avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “isocyanate” is a chemical that contains at least one isocyanate group in its structure. An isocyanate group is represented by the formula: N═C═O. An isocyanate that contains more than one, or at least two, isocyanate groups is a “polyisocyanate.” An isocyanate that has two isocyanate groups is a di-isocyanate and an isocyanate that has three isocyanate groups is a tri-isocyanate, etc. An isocyanate may be aromatic or aliphatic.

A “polyol” is an organic compound containing multiple hydroxyl (—OH) groups. In other words, a polyol contains at least two hydroxyl groups. Non-limiting examples of suitable polyols include diols (which contain two hydroxyl groups), triols (which contain three hydroxyl groups), and multi-hydroxyl containing polyols. Polyether polyols may include also a small amount of mono functional species (monols), namely species carrying only one hydroxyl group, as formed during the synthesis of the polyol as part of side reactions forming unsaturated species, namely species carrying double bonds.

A “polyether” is a compound containing two or more ether linkages in the same linear chain of atoms.

A “polyester” is a compound containing two or more ester linkages in the same linear chain of atoms.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer” (which is used interchangeably with the term “copolymer”) includes bipolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

“Hydroxyl number” represents the content of hydroxyl group in a polyol. The methods for measuring hydroxyl number are well known to those skilled in the art and are disclosed by, for example, Houben Weyl, Methoden der Organischen Chemie, vol. XIV/2 Makromolekulare Stoffe, p. 17, Georg Thieme Verlag; Stuttgart 1963.

“Average equivalent weight” is the average of the equivalent weight associated with the various ingredients in a mixture. When the mixture is formed by different polyols, the average equivalent weight may be calculated as follows: measure the average OH number of the mixture using one of the various experimental techniques well known in the art, such as titration or near infrared spectroscopy, as OHav: then calculate the average equivalent weight as

$$EWav = 56100 / OHav .$$

“Average functionality” is the average of the functionality associated with the various ingredients in a mixture. When the mixture is formed by different polyols, the average functionality may be calculated as follows:

$$Functionality av . = x 1 f 1 + x 2 f 2$$

where x1 and x2 are the molar ratios of the polyol 1 and the polyol 2, which have respectively functionality f1 and f2.

### The Isocyanate Component A)

The isocyanate component A) may comprise A1) a first polyisocyanate compound.

### The First Polyisocyanate Compound A1

According to various embodiments of the present disclosure, the first polyisocyanate compound A1 used for the component A is an aromatic compound having at least two isocyanate groups. According to a preferable embodiment of the present disclosure, the polyisocyanate compound comprises at least one aromatic ring (e.g. aryl group or heteroaryl group) and all the isocyanate groups in the polyisocyanate compound are directly attached to the aromatic rings without the existence of any interlink group therebetween. Carbodiimide modified derivatives of the above stated aromatic polyisocyanates may also be used for polyisocyanate compound A1, wherein the term carbodiimide modified derivatives may comprise carbodiimide modified aromatic polyisocyanates comprising at least two isocyanate groups. In another preferable embodiment, suitable aromatic polyisocyanate compounds include m-phenylene diisocyanate, 2,4-toluene diisocyanate and/or 2,6-toluene diisocyanate (TDI), the various isomers of diphenylmethanediisocyanate (MDI), the various oligomers of MDI that are present in polymeric MDI (polyphenylmethane polyisocyanate), carbodiimide modified MDI products, or mixtures thereof. In another preferable embodiment, suitable aromatic polyisocyanate compounds include the various isomers of diphenylmethanediisocyanate (MDI), and carbodiimide modified MDI products. In another preferable embodiment, suitable aromatic polyisocyanate compounds include the various isomers of diphenylmethanediisocyanate (MDI) in monomeric form, polymeric form or a combination thereof.

Generally, the amount of the first polyisocyanate compound A1 may vary based on the actual requirement of the polyurethane product. For example, as one illustrative embodiment, the content of the first polyisocyanate A1 compound can be from 15 wt % to 70 wt %, 15 wt % to 60 wt %, or from 18 wt % to 50 wt %, or from 23 wt % to 40 wt %, or from 25 wt % to 37 wt %, based on the total weight of the polyurethane composition.

In another preferable embodiment, the content of the first polyisocyanate compound A1) can be from 30 wt % to 100 wt %, or from 30 wt % to 95 wt %, or from 30 wt % to 90 wt %, or from 35 wt % to 90 wt %, or from 40 wt % to 85 wt %, or from 45 wt % to 80 wt %, or 50 wt % to 75 wt %, based on the total weight of the isocyanate component A).

The isocyanate component A) may further comprise a prepolymer that is formed by reaction of a polyisocyanate compound, which may be described in similar manner as the component A1 was previously described, and a polyol, wherein the prepolymer has a NCO content of 10-25% based on the weight of the prepolymer. Preferably, the amount of the prepolymer can be 10-70 wt %, or from 10 wt % to 65 wt %, or from 15 wt % to 60 wt %, or from 20 wt % to 55 wt %, or from 25 wt % to 40 wt %, based on the total weight of the isocyanate component A).

More preferably, the isocyanate component A) may further comprise at least one of A2) or A3), in addition to the first polyisocyanate compound A1):
A2) a first prepolymer that is formed by reaction of a second polyisocyanate compound and a second polyol, wherein the second polyol has an average equivalent weight of from 30 to 200 g/eq and an average functionality of 2-3 and the first prepolymer has a NCO content of 21-25% based on the weight of the first prepolymer;
A3) a second prepolymer that is formed by reaction of a third polyisocyanate compound and a third polyol, wherein the third polyol has an average equivalent weight of from 250 to 3000 g/eq and an average functionality of 2-3 and the second prepolymer has a NCO content of 10-20% based on the weight of the second prepolymer;
wherein the total amount of the first prepolymer A2) and the second prepolymer A3) is 10-70 wt %, or from 10 wt % to 65 wt %, or from 15 wt % to 60 wt %, or from 20 wt % to 55 wt %, or from 25 wt % to 40 wt %, based on the total weight of the isocyanate component A).

### The First Prepolymer A2

The first prepolymer A2, is formed by reaction of a second polyol with a second polyisocyanate compound. The second polyisocyanate compound can be monomeric isocyanate or polymeric isocyanate, wherein the monomeric isocyanate refers to an isocyanate molecule that in any case carries 2 NCO groups, such as MI or TDI. The second polyisocyanate compound used for forming the prepolymer A2 is an aromatic compound having at least two isocyanate groups: it may be described in similar manner as the component A1 was previously described.

The second polyol component used in the prepolymer A2, has an average equivalent weight of from 30 to 200 g/eq and an average functionality of 2-3. In one preferable embodiment of the present application, the polyol is selected from the group consisting of ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, tripropylene glycol, dibutylene glycol, tributylene glycols, trimethylolpropane, glycerol, pentaerythritol, and sugar compounds such as, for example, glucose, sorbitol, mannitol and sucrose, polyhydric phenols, resols and any combination thereof. In another preferable embodiment, the polyol is a polyether polyol, which can be prepared by reacting an olefin oxide (in a broad sense, which may include tetrahydrofuran) with a starter in the presence of a catalyst. The catalyst is preferably but not limited to an alkaline hydroxide, an alkaline alkoxide, antimony pentachloride, boron trifluoride-diethyl etherate or a combination thereof. Suitable polymerization catalysts may include potassium hydroxide, cesium hydroxide, boron trifluoride, or a double cyanide complex (DMC) catalyst such as zinc hexacyanocobaltate or quaternary phosphazenium compound. The olefin oxide is preferably but not limited to tetrahydrofuran, ethylene oxide, propylene oxide, 1,2-butylene oxide, 2,3-butylene oxide, styrene oxide, or a combination thereof; preferably ethylene oxide and/or propylene oxide. The starter molecule is one of the ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, tripropylene glycol, dibutylene glycol, tributylene glycols, trimethylolpropane, glycerol, pentaerythritol, and sugar compounds such as, for example, glucose, sorbitol, mannitol and sucrose, polyhydric phenols, resols and any combination thereof.

The content of the second polyol in prepolymer A2 can be adjusted by the skilled in the art as long as the resulting prepolymer A2 has a NCO content of from 21 wt % to 25 wt %, preferably a NCO content of from 22 wt % to 24 wt %, based on the total weight of the first prepolymer.

Prepolymer A2 has a NCO content of from 21 wt % to 25 wt %, preferably a NCO content of from 22 wt % to 24 wt %, based on the total weight of the first prepolymer.

### The Second Prepolymer A3

The second prepolymer A3, is formed by reaction of a third polyol with a third polyisocyanate. The third polyisocyanate compound used for forming the prepolymer A3 is an aromatic compound having at least two isocyanate groups: it may be described in similar manner as the component A1 was previously described.

The third polyol component used in the prepolymer A3 is a polyether polyol which can be prepared by reacting an olefin oxide (in a broad sense, which may include tetrahydrofuran) with a starter in the presence of a catalyst. The catalyst is preferably but not limited to an alkaline hydroxide, an alkaline alkoxide, antimony pentachloride, boron trifluoride-diethyl etherate or a combination thereof. Suitable polymerization catalysts may include potassium hydroxide, cesium hydroxide, boron trifluoride, or a double cyanide complex (DMC) catalyst such as zinc hexacyanocobaltate or quaternary phosphazenium compound. The olefin oxide is preferably but not limited to tetrahydrofuran, ethylene oxide, propylene oxide, 1,2-butylene oxide, 2,3-butylene oxide, styrene oxide, or a combination thereof; preferably ethylene oxide and/or propylene oxide. The starter molecules include compounds having at least 1, preferably from 2 to 8 hydroxyl groups, more preferably from 2 to 4 hydroxyl groups per molecule: they may include one or more primary amine groups in the molecule. Suitable starter molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Starter molecules having 1 or more primary amine groups in the molecules may be selected for example from the group consisting of aniline, ethylenediamine, TDA (toluenediamine), MDA (methylenedianiline) and PMDA (polymeric MDA), more preferably from the group comprising TDA and PMDA, an most preferably TDA.

In one preferable embodiment of the present application, the third polyol component used in the prepolymer A3 comprises at least one polyether polyol, and has an average functionality of 2-3, and an equivalent weight 250 to 3,000 g/eq, more preferably 500 to 2,500 g/eq, even more preferably 1,000 to 2,000 g/eq.

The content of the third polyol component used in the prepolymer A3 is from 20 wt % to 70 wt %, preferably 35 wt % to 70 wt %, more preferably 40 wt % to 60 wt % based on the total weight of prepolymer A3.

Prepolymer A3 has a NCO content of from 10 wt % to 20 wt %, or from 12 wt % to 19 wt %, or from 13 wt % to 18 wt %, or from 14 wt % to 16 wt %.

Prepolymer A2 may be referred to as the first prepolymer, and prepolymer A3 may be referred to as the second prepolymer.

The first prepolymer A2 and the second prepolymer A3 can be used individually or in combination in any ratio.

The total weight of the first prepolymer and the second prepolymer is from 10 wt % to 70 wt %, or from 10 wt % to 65 wt %, or from 15 wt % to 60 wt %, or from 20 wt % to 55 wt %, or from 25 wt % to 40 wt %, based on the total weight of the isocyanate component A.

### B1) the First Polyol

The second polyol is the one used in the synthesis of prepolymer A2. The third polyol is the one used in the synthesis of prepolymer A3. The first polyol B1 is part of the isocyanate-reactive component B) of the polyurethane composition of the invention. The first polyol B1 has an average equivalent weight of from 80 to 600 g/eq, preferably 80 to 510 g/eq, and an average functionality of 2-5, or preferably 2-3. It includes the polyols commonly used to prepare polyurethane in the art, including but not limited to polyether polyols, polycarbonate polyols, polyester polyols, or combinations thereof.

The polyether polyol may be prepared by a known process, for example, by reacting an olefin oxide (in a broad sense, which may include tetrahydrofuran) with a starter in the presence of a catalyst. The catalyst is preferably but not limited to an alkaline hydroxide, an alkaline alkoxide, antimony pentachloride, boron trifluoride-diethyl etherate or a combination thereof. The olefin oxide is preferably but not limited to tetrahydrofuran, ethylene oxide, propylene oxide, 1,2-butylene oxide, 2,3-butylene oxide, styrene oxide, or a combination thereof; preferably ethylene oxide and/or propylene oxide. Suitable starter molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Starter molecules having 1 or more primary amine groups in the molecules may be selected for example from the group consisting of aniline, ethylenediamine, TDA (toluenediamine), MDA (methylenedianiline) and PMDA (polymeric MDA), more preferably from the group comprising TDA and PMDA, an most preferably TDA.

The polyester polyol is prepared by reaction between a dibasic carboxylic acid or a dibasic carboxylic anhydride and a polyol. The dibasic carboxylic acid is preferably but not limited to an aliphatic carboxylic acid having 2-12 carbons, preferably but not limited to succinic acid, malonic acid, glutaric acid, adipic acid, suberic acid, azelaic acid, sebacic acid, dodecanoic acid, maleic acid, fumaric acid, phthalic acid, isophthalic acid, terephthalic acid, or a combination thereof. The dibasic carboxylic anhydride is preferably but not limited to phthalic anhydride, tetrachlorophthalic anhydride, maleic anhydride or a combination thereof. The polyol that reacts with the dibasic carboxylic acid or anhydride is preferably but not limited to ethylene glycol, diethylene glycol, 1,2-propanediol, 1,3-propanediol, dipropylene glycol, 1,3-methylpropanediol, 1,4-butanediol, 1,5-pentanediol, 1,6-hexanediol, neopentyl glycol, 1,10-decanediol, glycerine, trimethylolpropane, or a combination thereof. The polyester polyol also includes a polyester polyol prepared from a lactone. The polyester polyol prepared from a lactone is preferably but not limited to ε-caprolactone.

The polycarbonate polyol may be prepared by addition of carbon dioxide and an alkylene oxide compound to a starter comprising active hydrogen in the presence of a double metal cyanide catalyst. Also suitable for the purpose of the invention, are polycarbonate diols prepared by reacting a diol with a dihydrocarbyl carbonate or a diaryl carbonate or phosgene. The diol is preferably but not limited to 1,2-propanediol, 1,3-propanediol, 1,4-butanediol, 1,5-pentanediol, 1,6-hexanediol, diethylene glycol, trioxymethylene diol or a mixture thereof. The dihydrocarbyl or diaryl carbonate is preferably but not limited to diphenyl carbonate.

Generally, the amount of the first polyol may vary based on the actual requirement of the polyurethane product. For example, as one illustrative embodiment, the content of the first polyol can be from 10 wt % to 40 wt %, or from 12 wt % to 35 wt %, or from 14 wt % to 30 wt %, or from 15 wt % to 25 wt %, or from 16 wt % to 20 wt % based on the total weight of the polyurethane composition.

### B2) the Isocyanate Reactive (Meth)Acrylate Monomer

The isocyanate reactive (meth)acrylate monomer B2 has at least one C═C bond and at least one isocyanate reactive group, such as OH. The isocyanate reactive (meth)acrylate monomer B2 can be selected from hydroxy C1-10 alkyl (meth)acrylate monomers, more preferably hydroxy C1-6 alkyl (meth)acrylate monomers, even more preferably hydroxypropyl (meth)acrylate monomer, hydroxyethyl (meth)acrylate, or hydroxybutyl (meth)acrylate monomer.

The term (meth)acrylate is meant to include both the corresponding acrylate as well as the methacrylate structure: thus, the term hydroxypropyl (meth)acrylate may correspond to hydroxypropylmethacrylate and/or to hydroxypropylacrylate.

Generally, the amount of the isocyanate reactive (meth)acrylate monomer may vary based on the actual requirement of the polyurethane product. For example, as one illustrative embodiment, the content of the isocyanate reactive (meth)acrylate monomer can be from 15 wt % to 40 wt %, or from 20 wt % to 38 wt %, or from 25 wt % to 35 wt %, or from 27 wt % to 32 wt %, based on the total weight of the polyurethane composition.

### B3) the Acetoacetoxy Functional or Acetoacetamido Functional (Meth)Acrylate Monomer

The acetoacetoxy functional or acetoacetamido functional (meth)acrylate monomers are (meth)acrylate monomers having one or more acetoacetoxy functional groups or one or more acetoacetamido functional groups. The acetoacetoxy functional or acetoacetamido functional (meth)acrylate monomers can be represented by the following formula:

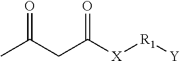

wherein X is O or N, R₁ is a divalent hydrocarbon radical, preferably C₁-C₆ alkyl, or C₂-C₄ alkyl, Y is a (meth)acrylate group.

The acetoacetoxy functional or acetoacetamido functional (meth)acrylate monomer useful in the present invention may include, acetoacetoxyethyl methacrylate (AAEM), acetoacetoxyethyl acrylate, acetoacetoxypropyl (meth)acrylate, acetoacetoxybutyl (meth)acrylate, acetoacetamido ethyl methacrylate, acetoacetamidoethyl acrylate, acetoacetamidopropyl (meth)acrylate, acetoacetamidobutyl (meth)acrylate, or combinations thereof.

Generally, the amount of the acetoacetoxy functional or acetoacetamido functional (meth)acrylate monomer may vary based on the actual requirement of the polyurethane product. For example, as one illustrative embodiment, the content of the acetoacetoxy functional or acetoacetamido functional (meth)acrylate monomer can be from 0.5 wt % to 15 wt %, or from 1 wt % to 14 wt %, or from 1.5 wt % to 13 wt %, or from 2.0 wt % to 12 wt %, or from 3.0 wt % to 11 wt %, or from 4.0 wt % to 10.5 wt %, or from 7.0 wt % to 10 wt % based on the total weight of the polyurethane composition.

### C) The Free Radical Initiator

The free radical initiator can be azo compound or peroxide. Preferably, the azo compound can be 2,2-azobisisobutyronitrile (AIBN); the peroxide can be selected from the group consisting of tert-butyl peroxybenzoate, butyl 4,4-di(tert-butylperoxy)valerate, di-tert-amyl peroxide, dicumyl peroxide, di(tert-butylperoxyisopropyl) benzene, 2,5-dimethyl-2,5-di(tert-butylperoxyl)hexane, tert-butyl cumyl peroxide, 2,5-dimethyl-2,5-di(tert-butylperoxyl)hexyne-3, di-tert-butyl peroxide, 3,6,9-triethyl-3,6,9-trimethyl-1,4,7-triperoxonane, isopropylcumyl hydroperoxide, 1,1,3,3-tetramethylbutyl hydroperoxide, cumyl hydroperoxide, tert-butyl hydroperoxide, and any combinations thereof.

In general, the content of the free radical initiator used herein is larger than zero, at least 0.1 wt %, or at least 0.2 wt %, or at least 0.3 wt % and is at most 6.0 wt %, preferably at most 5.0 wt %, more preferably at most 4.0 wt %, more preferably at most 3.0 wt % or at most 2.0 wt %, or at most 1.0 wt %, based on the total weight of the polyurethane composition.

### D) Other Additives

The polyurethane composition further optionally comprises other additives. The additives can be selected from the group consisting of catalysts for the reaction between the isocyanate group and the hydroxyl group, radical polymerization accelerators, defoamers, pigments, fillers, inhibitors and moisture scavengers.

The polyurethane composition of the present application may comprise one or more catalysts that can promote the reaction between the isocyanate group and the hydroxyl group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; titanium (IV) based catalysts such as such as tetraisopropyl titanate, tetra(n-butyl) titanate, tetraoctyl titanate, titanium acetic acid salts, titanium diisopropoxybis(acetylacetonate), and titanium diisopropoxybis (ethyl acetoacetate); zirconium-based catalysts such as zirconium tetraacetylacetonate, zirconium hexafluoroacetylacetonate, zirconium trifluoroacetylacetonate, tetrakis (ethyltrifluoroacetyl-acetonate) zirconium, tetrakis(2,2,6,6-tetramethyl-heptanedionate), zirconium dibutoxybis (ethylacetoacetate), and zirconium diisopropoxybis (2, 2, 6, 6-tetramethyl-heptanedionate); or mixtures thereof. According to a most preferable embodiment of the present disclosure, the catalyst for the reaction between the isocyanate component A) and the isocyanate-reactive component B), or the reaction between the second polyisocyanate and the second polyol or the reaction between the third polyisocyanate and the third polyol is a bismuth salts of organic carboxylic acids or tin salts of organic carboxylic acids, e.g., bismuth (III) octanoate or bismuth (III) neodecanoate, or tin octanoate.

In general, the content of the catalyst used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise a radical polymerization accelerator. The accelerator can be selected from all types of metallic or amine accelerators. In general, the content of the accelerator used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise an inhibitor. The inhibitor can be commonly used inhibitors, such as hydroquinone monomethyl ether (MeHQ). In general, the content of the inhibitor used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise a defoamer. The defoamer can be silicone or organic defoamers. In general, the content of the defoamer used herein is larger than zero and is at most 2.0 wt %, preferably at most 1.5 wt %, more preferably at most 1.0 wt %, more preferably at most 0.8 wt %, or at most 0.5 wt % based on the total weight of the polyurethane composition.

The polyurethane composition of the present application may optionally comprise a moisture scavenger. The moisture scavenger can be commonly used zeolites or liquid water scavengers. In general, the content of the moisture scavenger used herein is larger than zero and is at most 10 wt %, preferably at most 8 wt %, more preferably at most 7 wt %, more preferably at most 6 wt % or at most 5 wt %, or at most 1 wt %, based on the total weight of the polyurethane composition.

According a preferable embodiment of the present disclosure, the polyurethane composition is substantially free of water or moisture intentionally added therein. For example, “free of water” or “water free” means that the mixture of all the raw materials used for preparing the polyurethane composition comprise less than 3% by weight, preferably less than 2% by weight, preferably less than 1% by weight, more preferably less than 0.5% by weight, more preferably less than 0.2% by weight, more preferably less than 0.1% by weight, more preferably less than 100 ppm by weight of water based on the total weight of the mixture of raw materials.

The polyurethane composition of the present invention may further comprise conventional additives such as, for example, light stabilizers, ultraviolet (UV) absorbing compounds, leveling agents, wetting agents, dispersants, neutralizers, or rheology modifiers, or mixtures thereof. These additives may be present in an amount of from zero to 20%, from 0.1 to 10%, by weight based on the weight of the polyurethane composition.

The curing of the polyurethane composition of the present disclosure, which is actually a PU-acrylate hybrid formulation, is based on heat induced radical polymerization and polyol+isocyanate addition polymerization. The polyurethane resin obtained in the present disclosure is a polyurethane-polyacrylate hybrid resin system. The acetoacetoxy functional or acetoacetamido functional (meth)acrylate monomer B3 can improve the degree of conversion of the NCO groups in the polyurethane composition of the present disclosure, leading to improved resin properties after cure. The polyurethane resin of the present invention may be prepared with techniques known in the art. The process of preparing the polyurethane resin typically comprises:
1) providing an isocyanate component A),
2) providing an isocyanate-reactive component B), comprising
   B1) a first polyol;
   B2) an isocyanate reactive (meth)acrylate monomer; and
   B3) an acetoacetoxy functional or acetoacetamido functional (meth)acrylate monomer;
3) providing a free radical initiator C); and
4) then reacting the isocyanate component A) with the isocyanate-reactive component B) in the presence of the free radical initiator C) to form the polyurethane resin.

If optionally other additives D) as known in the art, such as catalysts for the reaction between the isocyanate group and the hydroxyl group, radical polymerization accelerators, defoamers, pigments, fillers, inhibitors and moisture scavengers are used, the process of preparing the polyurethane composition typically comprises
1) providing an isocyanate component A),
2) providing an isocyanate-reactive component B), comprising
   B1) a first polyol;
   B2) an isocyanate reactive (meth)acrylate monomer; and
   B3) an acetoacetoxy functional or acetoacetamido functional (meth)acrylate monomer;
3) providing a free radical initiator C);
4) providing optionally other additives D); and
5) then reacting the isocyanate component A) with the isocyanate-reactive component B) in the presence of the free radical initiator C) and optionally other additives D) to form the polyurethane composition described herein.

The polyurethane composition of the present invention may be prepared by a one-shot process. The polyurethane composition of the present invention may be prepared without the use of any reactive diluents such as styrene, methyl methacrylate.

The polyurethane composition can be cured at temperatures ranging from 4° C. to 150° C., preferably ranging from ambient temperature (25° C.) to 80° C.

The polyurethane composition can be used in the preparation of a composite material.

Thus, the composite material of the present application comprises a fiber reinforcement material and the polyurethane composition described herein. The fiber reinforcement material can be any fiber, including glass fiber or carbon fiber, as known in the art.

The description hereinabove is intended to be general and is not intended to be inclusive of all possible embodiments of the invention. Similarly, the examples herein below are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof, and the like; and that those skilled in the art will recognize that such may be varied within the scope of the claims appended hereto.

### Examples

The materials used in the examples are provided in Table 1 below.

TABLE 1
Raw materials used in the examples

| Ingredient | Description | Supplier |
|---|---|---|
| Polyol 1 | Propoxylated glycerine, | Dow |
| | OH number = 384 mg KOH/g | |
| Hydroxypropyl | Hydroxy functionalized unsaturated monomer | Sigma Aldrich |
| methacrylate (HPMA) | | |
| AAEM | Acetoacetoxy Ethyl Methacrylate | Eastman |
| BYK-A 530 | Silicone and polymer containing defoamer | BYK |
| INCOZOL ™ 2 | Moisture scavenger | Incorez |
| Accelerator 553s | Cobalt complex (1.9% cobalt content) | Nouryon |
| (accelerator) | containing cobalt octoate. | |
| TRIGONOX ™ C | Tert-butyl peroxylbenzoate (TBPB) | Nouryon |
| (Initiator) | | |
| ISOCYANATE 1 | Mixture of Pure and Polymeric MDI, | Dow |
| | NCO % = 32%, visc@25 C. = 50 mPa · s | |
| Prepolymer 1 | Formed by the reaction of 4,4′-MDI and TPG | prepared in the |
| | (tripropylene glycol). NCO % = 23% | “Synthesis of the |
| | | prepolymers 1 and 2” |
| | | Section |
| Prepolymer 2 | Formed by the reaction of Polyol 2 (12.6%), | prepared in the |
| | Polyol 3 (37.5%), Isocyanate 1 (31.8%) and | “Synthesis of the |
| | Isocyanate 2 (18.1%). NCO % = 15% | prepolymers 1 and 2” |
| | | Section |
| Polyol 2 | Polypropylene glycol, | Dow |
| | OH number = 56 mg KOH/g | |
| Polyol 3 | Propoxylated glycerine, with 15% EO cap, | Dow |
| | OH number = 28 mg KOH/g | |
| Isocyanate 2 | Monomeric MDI consisting of about 67% | Dow |
| | 4,4′-MDI and 33% 2,4′-MDI content | |

### Formulations and Test Results

### Synthesis of the Prepolymers 1 and 2:

These prepolymers were formed by reaction of isocyanate components with polyol components. The isocyanate components were added to a reactor and brought under stirring to the reaction temperature (about 70° C.), under nitrogen padding. The polyol components were premixed in case they consisted of more than one component, then added progressively into the reactor at a speed that is sufficiently low to allow removal of the exotherm generated by the reaction of the isocyanate groups with the hydroxyl groups. After completing the addition of the polyol components, the prepolymer was digested by keeping it under stirring at about 70° C., while monitoring the NCO content according to ASTM D5155. The prepolymer formation was considered complete when the NCO reached the target NCO value. Further considerations applied as known by one of ordinary skill in the art of manufacturing prepolymers.

Prepolymer 1: it has an NCO content=23% and a viscosity @25C=575 mPa·s. It was formed by the reaction of 4,4′-monomeric MDI (87 wt %) with tripropylene glycol (13 wt %) Prepolymer 2: it has an NCO content=15%. It was formed by the reaction of isomeric mixture of ISOCYNATE 2 (18.1 wt %), and ISOCYNATE 1 (31.8 wt %), with Polyol 2 (polypropylene glycol with EW=1002 g/eq, OH number=56 mg KOH/g) (12.6 wt %), and with Polyol 3 (propoxylated glycerine with 15% EO cap and with EW=2040 g/eq, OH number=28 mg KOH/g) (37.5 wt %).

### Sample Preparation

All components were blended in the specified proportions in the order according to the table list, followed by thoroughly mixing using SpeedMixer (DAC 600.1FVZ, Hauschild) in a dynamic program (800 rpm for 10 s, 1200 rpm for 10 s, 1600 rpm for 10 s, 2000 rpm for 2 min). The obtained liquid resin was further degassed for 6 min under vacuum, and casted into a vertical steel mold and left in the oven at 40° C. for 1 hour, followed by 70° C. overnight for complete curing. The casting plates were obtained by demolding on the next morning for cutting and testing.

### Inventive Example 1-3

Inventive Examples 1-3 were prepared according to the recipes shown in Table 2.

### Comparative Examples 1

Comparative Examples 1 did not use AAEM compared to the Inventive Examples.

The isocyanate index is the ratio of NCO groups (from the isocyanate and prepolymer components) and NCO reactive groups (from the polyol and HPMA and other isocyanate reactive components), multiplied by 100. Thus an index=100 corresponds to the situation in which the number of NCO groups is the same as the number of NCO reactive groups. The comparative and inventive examples were performed at the same isocyanate index of 102.7, corresponding to a small stoichiometric excess of NCO groups.

TABLE 2
Formulation details and key material properties for Inventive
Examples 1-3 and Comparative Example 1 with different AAEM %

| | Comparative | Inventive | Inventive | Inventive |
|---|---|---|---|---|
| Components | Example 1 | Example 1 | Example 2 | Example 3 |
| Polyol 1 | 16 | 16 | 16 | 16 |
| AAEM | 0 | 3 | 7 | 10 |
| HPMA | 27 | 27 | 27 | 27 |
| A530 | 0.3 | 0.3 | 0.3 | 0.3 |
| Incozol 2 | 2 | 2 | 2 | 2 |
| Accel. 553s (1.9%) | 0.02 | 0.02 | 0.02 | 0.02 |
| Isocyanate 1 | 32 | 32 | 32 | 32 |
| Prepolymer 1 | 7.7 | 7.7 | 7.7 | 7.7 |
| Prepolymer 2 | 5.7 | 5.7 | 5.7 | 5.7 |
| Trigonox C (TBPB) | 0.5 | 0.5 | 0.5 | 0.5 |
| ISO index | 102.7 | 102.7 | 102.7 | 102.7 |
| AAEM % | 0.0 | 3.2 | 7.1 | 9.9 |
| NCO residual ratio | 0.55 | 0.45 | 0.32 | 0.26 |
| HDT/° C. | 78 | 98 | 98 | 99 |

Inventive Example 1-3 were formulations containing AAEM at increasing levels from 3.2 wt % to 9.9 wt % in the hybrid polyurethane formulation. Comparative Example 1 was a formulation without any AAEM. The cured samples were characterized by FTIR for determining the residual unreacted NCO. Residual NCO was calculated by using the peak ratio of 2274 cm⁻¹ to 1520 cm⁻¹ which is assigned to free NCO and C═C as internal reference, respectively. As shown in Table 2, Comparative Example 1 showed significant amount of residual NCO, while by introducing AAEM, the residual NCO decreased drastically.

### Test Methods:

### Fourier Transform Infrared Spectroscopy-Attenuated Total Reflectance (FTIR-ATR)

FTIR-ATR results were collected on PerkinElmer Model with ATR accessory for the cured sample, and for the corresponding isocyanate mix. For each sample, 12 scans were collected. The NCO residual was calculated based on following equation:

$$NCO Residual ratio = \frac{( Height 2274 cm - 1 - Height 1520 cm - 1 ) cured sample}{( Height 2274 cm - 1 / Height 1520 cm - 1 ) Isocyanate mix}$$

where peak at 2274 cm-1 is assigned to unreacted NCO and peak 1520 cm-1 is assigned to the C═C from the benzene ring of MDI.

### Heat Distortion Temperature (HDT)

HDT was measured according to a protocol provided by TA instruments “Using the DMA Q800 for ASTM International D 648 Deflection Temperature Under Load”.

1. A polyurethane composition comprising
A) an isocyanate component comprising a prepolymer that is formed by reaction of a polyisocyanate compound and a polyol, wherein the prepolymer has a NCO content of 10-25% based on the weight of the prepolymer;
B) an isocyanate-reactive component comprising
B1) a first polyol;
B2) an isocyanate reactive (meth)acrylate monomer; and
B3) an acetoacetoxy functional or acetoacetamido functional (meth)acrylate monomer; and
C) a free radical initiator.

2. (canceled)

3. (canceled)

4. The composition of claim 1, wherein the content of the first polyisocyanate compound A1) is from 30 wt % to 90 wt % based on the total weight of the isocyanate component A).

5. The composition of claim 1, wherein the isocyanate component A) further comprises at least one of A2) or A3), in addition to the first polyisocyanate compound A1):
A2) a first prepolymer that is formed by reaction of a second polyisocyanate compound and a second polyol, wherein the second polyol has an average equivalent weight of from 30 to 200 g/eq and an average functionality of 2-3 and the first prepolymer has a NCO content of 21-25% based on the weight of the first prepolymer;
A3) a second prepolymer that is formed by reaction of a third polyisocyanate compound and a third polyol, wherein the third polyol has an average equivalent weight of from 250 to 3000 g/eq and an average functionality of 2-3 and the second prepolymer has a NCO content of 10-20% based on the weight of the second prepolymer;
wherein the total amount of the first prepolymer A2) and the second prepolymer A3) is 10-70 wt %, based on the total weight of the isocyanate component A).

6. The composition of claim 1, wherein the isocyanate reactive (meth)acrylate monomer B2) is selected from hydroxy C1-10 alkyl (meth)acrylate monomers.

7. The composition of claim 1, wherein the isocyanate reactive (meth)acrylate monomer B2) is selected from hydroxypropyl (meth)acrylate monomer and hydroxybutyl (meth)acrylate monomer.

8. The composition of claim 1, wherein the acetoacetoxy functional or acetoacetamido functional (meth)acrylate monomer B3) is represented by: 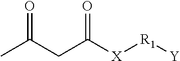
wherein X is O or N, R₁ is a divalent hydrocarbon radical, Y is a (meth)acrylate group.

9. The composition of claim 8, wherein the acetoacetoxy functional (meth)acrylate monomer B3) is selected from the group consisting of acetoacetoxyethyl methacrylate, acetoacetoxyethyl acrylate, acetoacetoxypropyl (meth)acrylate, acetoacetoxybutyl (meth)acrylate, or combinations thereof.

10. The composition of claim 8, wherein the content of the acetoacetoxy functional or acetoacetamido functional (meth)acrylate monomer is from 0.5 wt % to 15 wt %, based on the total weight of the polyurethane composition.

11. The composition of claim 1, wherein the content of the isocyanate reactive (meth)acrylate monomer B2) is from 15 wt % to 40 wt % based on the total weight of the polyurethane composition.

12. The composition of claim 1, wherein the first polyol has an average functionality of 2 to 5 and an average equivalent weight of 80 to 600 g/eq.

13. The composition of claim 1, wherein the polyurethane composition further comprises other additives selected from the group consisting of catalysts for the reaction between the isocyanate group and the hydroxyl group, radical polymerization accelerators, defoamers, pigments, fillers, inhibitors and moisture scavengers.

14. A composite material comprising a fiber reinforcement material and a polyurethane resin obtained from the polyurethane composition of claim 1.

15. A method of preparing a polyurethane resin comprising:
combining an isocyanate component A), an isocyanate-reactive component B); and a free radical initiator to form a polyurethane resin;
wherein an isocyanate component comprises a prepolymer that is formed by reaction of a polyisocyanate compound and a polyol, wherein the prepolymer has a NCO content of 10-25% based on the weight of the prepolymer; and
wherein isocyanate-reactive component B) comprises: B1) a first polyol; B2) an isocyanate reactive (meth)acrylate monomer; and B3) an acetoacetoxy functional or acetoacetamido functional (meth)acrylate monomer.
